(19) United States
(12) Patent Application Publication
(10) Pub. No.: US 2014/0197815 A1
(43) Pub. Date: Jul. 17, 2014

(54) TUNNELING CURRENT CIRCUIT

(71) Applicant: Mitsutoshi Sugawara, Yokohama-shi (JP)

(72) Inventor: Mitsutoshi Sugawara, Yokohama-shi (JP)

(21) Appl. No.: 13/261,789

(22) PCT Filed: May 21, 2012
(86) PCT No.: PCT/JP2012/062894

§ 371 Date: Dec. 5, 2013

(30) Foreign Application Priority Data
Jun. 12, 2011 (JP) 2011-130765

(51) Int. Cl. G05F 3/02

(52) U.S. Cl. CPC G05F 3/02
USPC 323/313

(57) ABSTRACT

The purpose of the present invention is to provide a circuit that generates a reference voltage with little electrical power consumption, and that has the similar as conventional circuits. A bandgap reference circuit that, to generate an output voltage, adds a voltage proportional to a differential voltage when currents having different current densities are applied to a semiconductor junction, and a voltage proportional to a forward voltage occurring in a semiconductor junction, wherein the bandgap reference circuit is characterized in that the “voltage proportional to the differential voltage” is generated by a first tunneling current element to which the differential voltage is applied, circuits connected to a second tunneling current element or a serial circuit of second tunneling current elements, and a means to apply, to the second tunneling current element, a current proportional to the current applied to the first tunneling current element.

### BACKGROUND OF THE INVENTION

1. Field of the Invention

This invention relates to analog circuits using tunneling currents, and more particularly useful tunneling current circuits to design ultralow power band gap reference (“BGR”) circuits.

BGR circuits are well known since 50 years ago. For example, the circuits cancel thermal coefficients consisting of forward-biased silicon PN junctions (“junctions”), which have approximate 0.7V and approximate −2 mV/deg (negative thermal coefficients), and voltage differences between different current density junctions multiplied by resistor ratios, which are proportion to absolute temperature (positive thermal coefficients).

### REFERENCE DOCUMENTS

1) Japan Patent Application #2002-304224 “Regulated Low Voltage Generation Circuit” inventor Mitsutoshi Sugawara

2) Japan Patent file #2010-235993 “Reference Voltage generator” inventor Mitsutoshi Sugawara, and it was not disclosed at this PCT filed date.

3) U.S. Pat. No. 6,384,586 “Regulated Low Voltage Generation Circuit” inventor Mitsutoshi Sugawara

FIG. 4 is a prior art described in the reference document 1) and 3), which are invented by this inventor.

It is CMOS BGR circuit fabricated in general CMOS process, and can be realized zero thermal coefficient and less than silicon's band gap voltage approximate 1.3V.

I explain brief principle and the circuit operations below.

Voltage VD1 generated at junction D1 by current source I1 is;

I1=Is*exp(q*VD1/(k*T))

Where Is is saturation current determined by process parameters and junction size, q is electric charge of an electron, k is Boltzmann's constant, and T is absolute temperature.

Also, voltage VD2 generated at junction D2 by current source I2 is;

I2=m*Is*exp(q*VD2/(k*T))

Here, Is is approximate same value on a LSI chip, and m is current density ratio. Then;

VD1−VD2=(k*T/q)*ln(m*I1/I2)

Hence, the differential voltage is in proportion to absolute temperature T. In a case of D2 size=10*D1 size, I1=I2, and room temperature T=300 degK, approximately V1−V2=60 mV.

Since a differential input voltage of a differential amplifier A1 becomes zero by using negative feedback, voltage of resistor R1 becomes VD1−VD2. Then I2=(VD1−VD2)/R1 by Ohm's low.

On the other hand, current I3=n*I2 flows into a breeder resistor R2 and R3 from voltage VD3 generated on junction D3 by bias current source I4. By Thevenin's theorem, Output voltage Vout is;

Vout=VD3*R3/(R2+R3)+I3*(R2//R3)

Here // means parallel resistor value, R2//R3=R2*R3/(R2+R3)

Hence Vout=VD3*R3/(R2+R3)+R2*R3/(R2+R3)/R1*n*k*T*ln(m)/q

The first term has negative thermal coefficient in proportion to junction voltage, and the second term has positive thermal coefficient in proportion to absolute temperature, so that we can choose negative, zero, or positive thermal coefficient by selecting R1, R2, R3, and m appropriately. Zero is often used in industry, and negative or positive ones may be used to compensate overall temperature coefficient.

For example, D2 size=10*D1 size, I1=I2=I3, R2=R3=10*R1, and room temperature T=300 degK, then m=10 and n=1, the first term is approximate 350 mV and −1 mV/degC as a half of junction voltage, and the second item is approximate 300 mV and +1 mV/degC. Total voltage is approximate 650 mV and temperature coefficient is canceled to be zero.

Power consumption of the circuit is determined by resistor R1 and the current mirror ratios. For example, in a case of R1=6 kΩ, voltage difference of R1=60 mV, then I2=10 μA, and I1+I2+I3+I4=40 μA. When power supply voltage=1V, the power consumption is 40 μW. Here R2=R3=60 kΩ. If we want to reduce it to 1/10 or 4 μW, R1=60 kΩ, but R2=R3=600 kΩ so it requires large area in a LSI. If we consider to reduce power consumption to 1/10000 or 400 pW, R2=R3=6GΩ, so it is too big to be laid out into industrial reasonable size LSI. Not only this particular circuit but almost all BGR circuits use similar principal, they have same problems to reduce power significantly.

### ADVANTAGES OF THIS INVENTION

By using this invention, we can realize novel BGR circuits having small size, and nW or less power consumption. Furthermore, by using this invention, we can realize novel BGR circuits having small size, nW or less power consumption, less than typical BGR 1.3V, and zero temperature coefficient. In addition to above, each internal circuit of the novel BGR circuits can be generally applicable to any small size and nW class circuits.

### SUMMARY OF THE INVENTION

### Meanings to Solve the Problem

This invention uses tunneling currents instead of resistors. We can observe tunneling current at approximate 10 nm or shorter length of insulator, and it was explained by quantum physics. In this invention, I call “tunneling current device” as an device which uses tunneling current proactively, and “tunneling current circuit” as a circuit which uses tunneling current device.

As an example of tunneling current device, we propose to use “gate tunneling leakage current”, which flows MOS transistor's gate to back gate when 90 nm or finer LSI processes. Since drain and source electrodes don't work in the case, they are not necessary. We can fabricate an electrode of the tunneling current device overlapped on thin insulator without drain and source ion_implantation_holes same time as MOS gate electrodes. We can also fabricate an ring aria at perimeter of tunneling current device same time MOS drain and source electrodes.

Tunneling current device can consist of very thin insulator film between electrodes, which is not related MOS transistors.

We use that tunneling currents' values are pA˜nA orders.

Reference voltage generation circuits, applying this invention with tunneling current devices, is;

A reference voltage generation circuit which output voltage is a proportional voltage to differential voltage between junctions' forward voltages at different current density, in addition to a proportional voltage of junction's forward voltages, wherein a circuit comprising;
a generation circuit of said proportional voltage to differential voltage comprising;
a first tunneling current device driven by said differential voltage,
a second tunneling current device or a serial circuit of a second tunneling current devices,
a mean which flows proportional current of said fist tunneling current device into said second tunneling current device or said serial circuit.

This invention also proposes means to reduce or to cancel undesirable tunneling currents in order to use desired tunneling current devices accurately,

### DESCRIPTION OF THE REFERENCED ENBODIMENTS

I explain the invention in detail referring FIG. 1.

When defining I1 as drain current of P channel transistor M3, voltage VD1 generated at junction D1 is;

I1=Is*exp(q*VD1/(k*T)).

Here, Is is saturation current determined by process and junction size, q is an electron charge, k is Boltzmann's constant, and T is absolute temperature. When defining I2 as drain current of P channel transistor M4, voltage VD2 generated at junction D2, which has 10× size of D1, is;

I2=10*Is*exp(q*VD2/(k*T)).

Hence, VD1−VD2=(k*T/q)*ln(10*I1/I2)

I.e. we can get a voltage in proportion to absolute temperature T above. When I1=I2, and room temperature T=300 degK, approximate V1−V2=60 mV.

Since a differential inputs of a differential amplifier, which consists of N channel transistors M6 and M7, active loads by P channel transistor M1 and M2, and substantially current source by a tunneling current device Ts, become zero with negative feedback, a voltage of tunneling current device T0 becomes VD1−VD2. This phenomenon is same as previous BGR except tunneling current device T0.

I propose to use tunneling leakage current between gate and back gate of P channel transistor as one of tunneling current transistor. For example, its drain and source electrode can be connected to back gate. This connection circuit can be simulated by existing circuit simulators with BSIM4 model, etc. Depend on process, but as an example, 30 um*30 um gate flows approximate 10 pA tunneling current. To set equal currents to P channel transistors M4 and M5, serial connection of tunneling current devices T1˜T10 and T0 flow same value currents, and each tunneling current device has same voltage value. Then the voltage between both end of serial connection of tunneling current devices T1˜T10 is 10× of T0's voltage. It is 600 mV and +2 mV/deg C. temperature coefficient as same as previous BGR.

The circuit outputs the voltage in addition to junction D3's forward voltage VD3 which has approximate 0.7V and −2 mV/deg C. temperature coefficient. The output voltage is approximate 1.3V and zero temperature coefficient. Since actually VD3's voltage and temperature coefficient slightly depend on process and current density, adjustments of number of tunneling current devices and/or sizes are required to realize zero or any other temperature coefficient.

This circuit consumes only several 10 pA, due to approximate 10 pA current sources. Total power consumption can be realized within several 10 pW˜100 pW. A characteristic thing is that smaller currents are realized in proportion to smaller sizes of tunneling current devices. For example, power consumption will be 1/9, when size of each tunneling current device becomes to 10 μm*10 μm. It marks contrast with previous BGR power consumption in inverse proportion to each resistor size. Above sizes and current values are examples to explain, and designers can modify them to fit requirements and processes.

Concerning MOS transistors' gate tunneling current leakages other than tunneling current devices, these MOS transistors can simply have thick gate insulator layer for higher voltage IO use without tunneling current. Number of serial tunneling current devices is not limited above example, it can be selected by area ratio of junction Di and D2. Voltage between both end of serial tunneling current devices T1˜T10 can be also adjusted by size ratio of P channel transistors M3 and M4. To increase output drivability, size of P channel transistor M5 becomes to 2× and size of each tunneling current device becomes 2×, as an example.

By a measurement result of MOS transistors in 90 nm or finer LSI processes, voltage and current relation of tunneling current devices is;

I1=a*V1ⁿ

I2=b*V2ⁿ

n is approximate 2.

When I1 and I2 are in proportion, or I2=m*I1;

b*V2ⁿ=m*a*V1ⁿ

Hence V2=(m*a/b)^{1/n}*V1

V1 and V2 are also in proportion.

As another application of the embodiment, size of tunneling current device T0 becomes 4× of T1. By using above equations with approximate n=2, m=1, approximate a=4, and b=1, voltage of T1 can be exactly 2× of T0. When sizes of T2˜T5 are same as T1, voltage of both end of serial T1˜T5 becomes 10× of T0, then T6˜T10 can be reduced (not shown in FIG. 1). This affects to reduce their sizes. This application is not limited to above values, and it can be selected any size ratios, which include fraction numbers, and number of tunneling current devices.

FIG. 2 shows other embodiment to realize lower reference voltage regulator than silicon band gap voltage. I put same symbols when same functions as FIG. 1, and skip explanations. Drain current of M5 generates 5× voltage of T0 at both end of serial connections of tunneling current devices T1˜T5. When same junction sizes as FIG. 1, the voltage is approximate 300 mV and −1 mV/deg C.

Additional P channel transistor M8 generates junction D3's forward voltage VD3, and tunneling devices T11˜T14 divide the voltage half, and then voltage follower circuit with differential amplifier A2 outputs half of VD3. The output voltage is approximate 350 mV and −1 mV/deg C. temperature coefficient. Sum of the voltage and said voltage of T1˜T5 is connected to terminal Vout. The output voltage Vout is approximate 650 mV and temperature coefficient is canceled to be approximate zero.

It is possible to select dividing ratio as 1/3 or 2/3, etc., and to select junction size ratio, number of serial tunneling current devices, and size ratio of serial tunneling current devices to realize desired voltage and temperature coefficient.

The embodiment can realize incommensurable lower power, 1V supply operation, and half band gap voltage. In a case of transistor sizes of M3, M4, M5, and M8=1:1:1:1, total power consumption is only 40 pW.

FIG. 3 shows transistor level schematic of FIG. 2. I put same symbols when same functions as FIG. 2, and skip explanations. In the case, all transistors in the schematic are assumed not to be negligible gate tunneling leakage currents. PNP transistors Q1, Q2, and Q3 are shorted each collector and gate, which work as equivalent diodes, as well known. In normal CMOS processes, PNP transistor which collector is substrate, base is N well, and emitter is P channel MOS transistors drain and source, is available without extra processes. I use it in FIG. 3.

PNP transistor Q3's forward biased voltage VD3 is divided to half by tunneling current devices T11˜T14. Here, T11 and T12 are connected reverse direction, to have common back gates in an N well, and reduce back gate electrodes and connection wire. Drains can also be common. T13 and T14 are same as T11 and T12. By using it, more smaller sizes are available.

Any division ratios are possible to select number of tunneling current devises and their sizes by using equations in 0017.

Differential amplifier A2 consists of P channel transistor pear M15 and M16, active load by N channel transistors M18 and M19, and N channel transistor M17 as a grounded source amplifier circuit. Since A2 works as a voltage follower, gate voltages of M15 and M16 are almost equal to its output, and back gates of M15 and M16 are connected there. Then gates and back gate voltages of both M15 and M16 are approximate 0V, and no currents flow. In other words, gate tunneling currents of M15 and M16 are ignored.

Drain current of M15 flows not only drain current of M18, but also gate tunneling currents of M18 and M19. To compensate them, gate tunneling current of M17 is set to sum of gate tunneling currents of M18 and M19. In detail, gate area of M17 should be approximately equal to sum of areas of M18 and M19, and these transistors' current densities should also be equal. Then these 3 transistors' gates—back gates voltages become equal, gates—back gates tunneling leakage current also become equal, and drain currents of M15 and M16 become equal when balanced.

Main parts of differential amplifier A1 are N channel transistor differential pair M6 and M7, active load consisting of P channel transistors M1 and M2, and almost constant current source consisting of tunneling current device Ts. When tunneling current device Ts consists of N channel transistor's gate—back gate on a substrate, it is smaller than P channel one.

P channel transistor M10, working as a constant current source, and N channel transistor M13, working as a diode, generate a voltage which is VGS higher than common source voltage of M6 and M7. Since the voltage is approximate equal to gate voltages of M6 and M7, the voltage biases to common back gates of these transistors. Then these transistors' gates—back gates voltages become approximate 0V, and no gate tunneling currents flow. To force different voltage other than substrate voltage to back gates of N channel transistors, it is well known, but not limited, deep N well process is added.

In order to compensate unbalance by gate tunneling currents of P channel transistors M1, M2, and M10, P channel transistor M11 is added. Source current of M11 is quite small due to only gate tunnel currents of M1, M2, and M10. Then M11 is as small as possible to reduce its gate tunneling current.

P channel transistor M12 is added to compensate gate tunneling currents of P channel transistors M3, M4, M5, M14, and M8 for next constant current circuit stages. When gate tunnel currents of M12 and said M11 become approximately equal, much better balance is available.

In the above description, I have explained to realize lower power BGR without less accuracy, even using transistors whose gate tunneling currents are not ignored, to be canceled, compensated, or reduced the undesired tunneling currents.

If necessary, stating circuit and countermeasures of oscillation for amplifiers A1 and A2 can be added.

This invention realize less than lnA BGR circuit, 4 digits smaller current than previous one, into similar size of previous one. Same time, other analog circuits' powers can also be reduced, by generally applying tunneling currents such as said differential amplifiers, current mirrors and active loads, voltage dividers, etc., and by generally compensating undesired tunneling currents. Using the invention, it is possible to increase operation times of portable equipment with buttery cells. In addition to them, it is also possible to use magnetic field, electric field, solar, and contact potential energies, and to apply equipment inside human body, etc. without buttery cells.

The invention is not limited above embodiments, and parts of the invention or any combinations of the parts of the invention can be applied.

### BRIEF DESCRIPTION OF THE DRAWINGS

FIG. 1 is the first embodiment, lower power consumption, approximate 1.3V, and zero temperature coefficient reference voltage regulator.

FIG. 2 is the second embodiment, lower power consumption, approximate 650 mV, and zero temperature coefficient reference voltage regulator.

FIG. 3 is the third embodiment, transistor level description schematic of FIG. 2.

FIG. 4 is an existing reference voltage regulator shown in a patent document described in 0003.

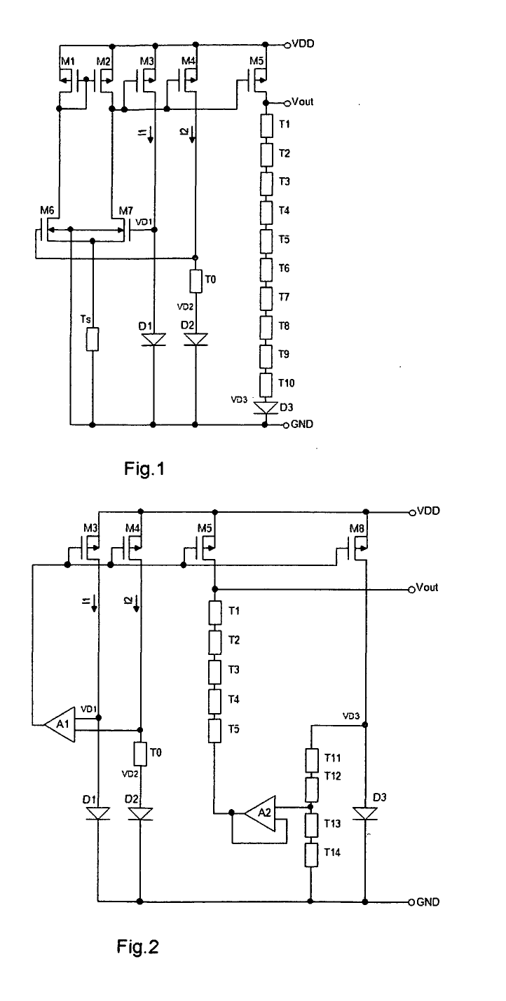

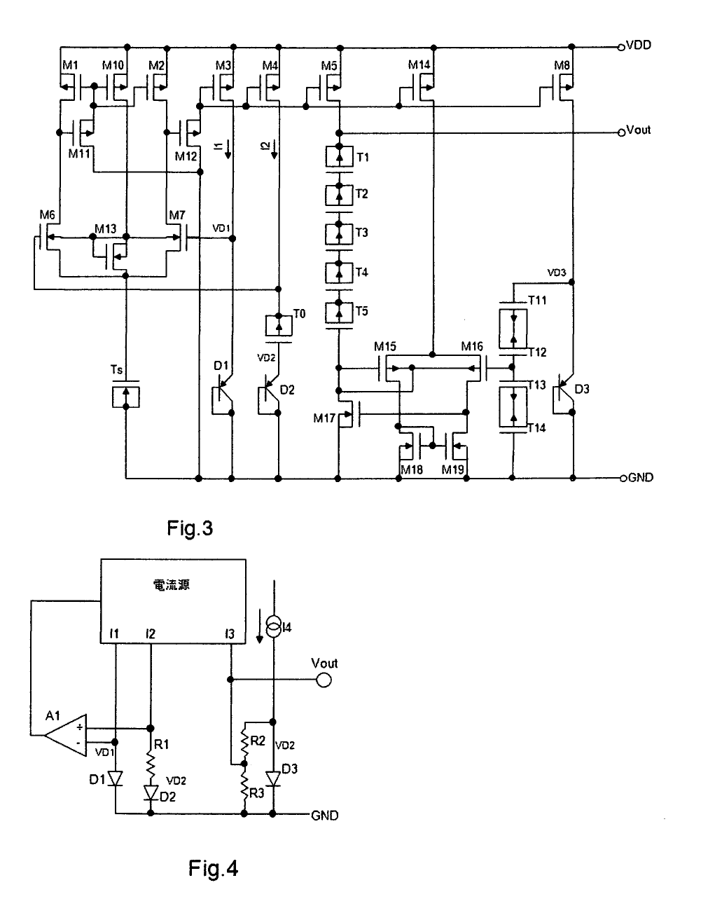

### EXPLANATIONS OF SYMBOLS ARE BELOW

T1˜T14, Ts tunneling current devices

D1˜D3 semiconductor PN junction diodes

M1˜M19 transistors

I0˜I4 current sources

R1˜R3 resistors

A1, A2 differential amplifiers

VDD voltage supply

GND ground

Vout output terminal or output voltage

What is new claimed is:

1. (canceled)

1. A tunneling current circuit of a differential amplifier, consisting of;
a MOS transistor pair, whose sources are commonly connected,
load(s), connected to at least one of drains of said transistor pair,
and signal(s) and bias(es), connected to gates of said transistor pair, wherein a tunneling current device, which connected between said sources and a positive or negative voltage supply.

2. A tunneling current circuit of a differential amplifier consisting of;
a MOS transistor pair, whose sources are commonly connected to substantial current source,
load(s), connected to at least one of drains of said transistor pair,
and signal(s) and bias(es), connected to gates of said transistor pair, wherein said transistor pair's back gates commonly connected to approximate same electric potential as at least one of said gates to reduce tunneling current between said gates and said back gates.

3. A tunneling current circuit of a differential amplifier consisting described in claim 2,
wherein said “approximate same potential” generated by a voltage follower circuit, which input is connected to electric potential of at least one of said gates.

4. (canceled)

4. A tunneling current circuit including a forward-biased MOS transistor,
whose back gate is connected to output of a voltage follower circuit of said transistor's gate, having approximate same electric potential as gate of said transistor to reduce tunnel current flowing between said gate and said back gate.

5. A tunneling current circuit including a first forward-biased MOS transistor,
whose back gate is connected to a electric potential of said first MOS transistor's source electric potential added by a voltage between gate and source of a second forward-biased MOS transistor, having approximate same electric potential as gate of said first MOS transistor to reduce tunnel current flowing between said gate and said back gate of said first MOS transistor.

6. (canceled)

6. A tunneling current circuit, consisting of;
a current mirror circuit consisting of at least two MOS transistors,
a third transistor whose source is connected to common gate connection of said current mirror transistors,
gate of said third transistor connected to one of drains of said current mirror transistors
and drain of said third transistor connected to an electric potential, which can flow enough gate tunnel currents of said current mirror transistors.

7. A band gap reference circuit which outputs a summing voltage of a proportional voltage of differential voltage between semiconductor PN junctions flowing currents at different current densities, and a proportional voltage of a forward-biased semiconductor PN junction,
wherein a first tunneling current device forced by said differential voltage,
a second tunneling current device or a serial circuit of second plural tunneling current devices,
and a mean which flows proportional current of current flowing through said first tunneling device to said second tunneling current device(s) to generate said “proportional voltage of differential voltage”.

8. A band gap reference circuit which outputs a summing voltage of a proportional voltage of differential voltage between semiconductor PN junctions flowing currents at different current densities, and a proportional voltage of a forward-biased semiconductor PN junction,
wherein a first tunneling current device forced by said differential voltage,
a second tunneling current device or a serial circuit of second plural tunneling current devices,
a mean which flows proportional current of current flowing through said first tunneling device to said second tunneling current device(s) to generate said “proportional voltage of differential voltage”,
a divider circuit consisting of a serial connection of at least third and fourth tunneling current devices to divide a forward-biased semiconductor PN junction,
and an amplifier buffering said divider output to generate said “proportional voltage of a forward-biased semiconductor PN junction”.

9. Said band gap reference circuits described in claim 7, and claim 8,
including amplifier(s) having said circuit(s) with at least one of tunnel current devices described in claim 1.˜claim 5.
